(19) United States
(12) Patent Application Publication
(10) Pub. No.: US 2021/0382651 A1
(43) Pub. Date: Dec. 9, 2021

(54) SCHEDULING MEMORY TRANSACTIONS

(71) Applicant: QUALCOMM Incorporated, San Diego, CA (US)

(72) Inventors: Jean-Jacques LECLER, Antibes (FR); Philippe BOUCARD, Le Chesnay (FR)

(21) Appl. No.: 16/894,550

(22) Filed: Jun. 5, 2020

(51) Int. Cl. G06F 3/06

(52) U.S. Cl. CPC G06F 3/0659; G06F 3/0673; G06F 3/0604

(57) ABSTRACT

In some aspects, the present disclosure provides a method for scheduling transactions for a memory by a scheduler. The method includes receiving a plurality of transactions, each of the plurality of transactions being associated with a corresponding priority level. The method also includes selecting one or more transactions of the plurality of transactions that meet one or more constraints based on one or more past transactions scheduled for the memory by the scheduler. The method also includes determining whether at least one transaction of the one or more transactions satisfies a threshold priority level.

### BACKGROUND

### Field of the Disclosure

The teachings of the present disclosure relate generally to memory operations, and more particularly, to techniques for efficient management of memory transactions.

### Description of the Related Art

Generally, an electronic memory device may include a scheduler configured to arbitrate memory transactions according to one or more constraints. For example, a scheduler may arbitrate memory transactions based on bandwidth, where the scheduler accounts for timing constraints between different transactions, such that a maximum number of transactions are communicated to the memory device during a given window of time. In another example, the scheduler may arbitrate memory transactions based on a priority of each of the memory transactions. In such an example, memory transactions having the highest priority are typically communicated to the memory device before transactions having relatively lower priorities.

However, arbitration based on bandwidth can result in urgent transactions being delayed, while arbitration based on priority can result in inefficient use of bandwidth. Thus, making use of a memory scheduler may pose challenges.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Certain aspects provide a method for scheduling transactions for a memory by a scheduler. In some examples, the method includes receiving a plurality of transactions, each of the plurality of transactions being associated with a corresponding priority level. In some examples, the method includes selecting one or more transactions of the plurality of transactions that meet one or more constraints based on one or more past transactions scheduled for the memory by the scheduler. In some examples, the method includes determining whether at least one transaction of the one or more transactions satisfies a threshold priority level. In some examples, the method includes, when at least one transaction of the one or more transactions satisfies the threshold priority level, scheduling a first transaction of the at least one transaction for the memory. In some examples, the method includes, adjusting the threshold priority level.

Certain aspects provide a scheduler configured to schedule transactions for a memory. In some examples, the scheduler includes a memory and a processor coupled to the memory, wherein the processor and the memory are configured to receive a plurality of transactions, each of the plurality of transactions being associated with a corresponding priority level. In some examples, the processor and the memory are configured to select one or more transactions of the plurality of transactions that meet one or more constraints based on one or more past transactions scheduled for the memory by the scheduler. In some examples, the processor and the memory are configured to determine whether at least one transaction of the one or more transactions satisfies a threshold priority level. In some examples, the processor and the memory are configured to, when at least one transaction of the one or more transactions satisfies the threshold priority level, schedule a first transaction of the at least one transaction for the memory. In some examples, the processor and the memory are configured to adjust the threshold priority level.

Certain aspects provide an apparatus configured to schedule transactions for a memory. In some examples, the apparatus includes a means for receiving a plurality of transactions, each of the plurality of transactions being associated with a corresponding priority level. In some examples, the apparatus includes a means for selecting one or more transactions of the plurality of transactions that meet one or more constraints based on one or more past transactions scheduled for the memory by the scheduler. In some examples, the apparatus includes a means for determining whether at least one transaction of the one or more transactions satisfies a threshold priority level. In some examples, the apparatus includes, when at least one transaction of the one or more transactions satisfies the threshold priority level, a means for scheduling a first transaction of the at least one transaction for the memory. In some examples, the apparatus includes a means for adjusting the threshold priority level.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an exemplary system-on-chip (SoC) integrated circuit in accordance with certain aspects of the present disclosure.

FIG. 2 is a block diagram conceptually illustrating an example embodiment of a memory scheduler for scheduling communication of memory transactions to improve bandwidth efficiency, in accordance with certain aspects of the present disclosure.

FIG. 3 is a block diagram conceptually illustrating an example embodiment of a memory scheduler for scheduling communication of memory transactions according to priority, in accordance with certain aspects of the present disclosure.

FIG. 4 is a block diagram conceptually illustrating an example embodiment of a memory scheduler for scheduling communication of memory transactions according to bandwidth efficiency and priority, in accordance with certain aspects of the present disclosure.

FIG. 5 is a block diagram conceptually illustrating an example embodiment of a memory scheduler for scheduling communication of memory transactions according to bandwidth efficiency and priority, in accordance with certain aspects of the present disclosure.

FIG. 6 is a block diagram conceptually illustrating an example embodiment of a memory scheduler for scheduling communication of memory transactions to improve bandwidth efficiency while also scheduling according to priority, in accordance with certain aspects of the present disclosure.

FIG. 7 is a clock signal timing diagram illustrating an example scenario for reducing bandwidth loss in memory transaction scheduling, in accordance with certain aspects of the present disclosure.

FIG. 8 is a clock signal timing diagram illustrating an example scenario for reducing bandwidth loss in memory transaction scheduling, in accordance with certain aspects of the present disclosure.

FIG. 9 is a flow diagram illustrating example operations for scheduling transactions for a memory by a scheduler in accordance with certain aspects of the present disclosure.

FIG. 10 illustrates a processing system that may include various components configured to perform operations for the techniques disclosed herein, such as the operations illustrated in FIG. 9.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with various other embodiments discussed herein.

The term “system on chip” (SoC) is used herein to refer to an integrated circuit (IC) chip or package that contains multiple resources and/or processors integrated on a substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., read-only memory (ROM), random access memory (RAM), Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects of the present disclosure. Such memory technologies/types include phase change memory (PRAM), dynamic random-access memory (DRAM), static random-access memory (SRAM), non-volatile random-access memory (NVRAM), flash memory (e.g., embedded multimedia card (eMMC) flash, flash erasable programmable read only memory (FEPROM)), pseudostatic random-access memory (PSRAM), double data rate synchronous dynamic random-access memory (DDR SDRAM), and other RAM and ROM technologies known in the art. The DDR SDRAM memory may include a personal computer double data rate (PC-DDR) SDRAM used in computers and servers, and are generally optimized for low latency. The DDR SDRAM may also include a low power double data rate (LP-DDR) SDRAM used in mobile devices, and generally optimized for low-power consumption. The DDR SDRAM may also include a graphics double data rate (G-DDR) SDRAM used in graphics processing units (GPUs), and generally optimized for high throughput.

Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language. Mobile computing device architectures have grown in complexity, and now commonly include multiple processor cores, SoCs, co-processors, functional modules including dedicated processors (e.g., communication modem chips, global positioning system (GPS) processors, display processors, etc.), complex memory systems, intricate electrical interconnections (e.g., buses and/or fabrics), and numerous other resources that execute complex and power intensive software applications (e.g., video streaming applications, etc.).

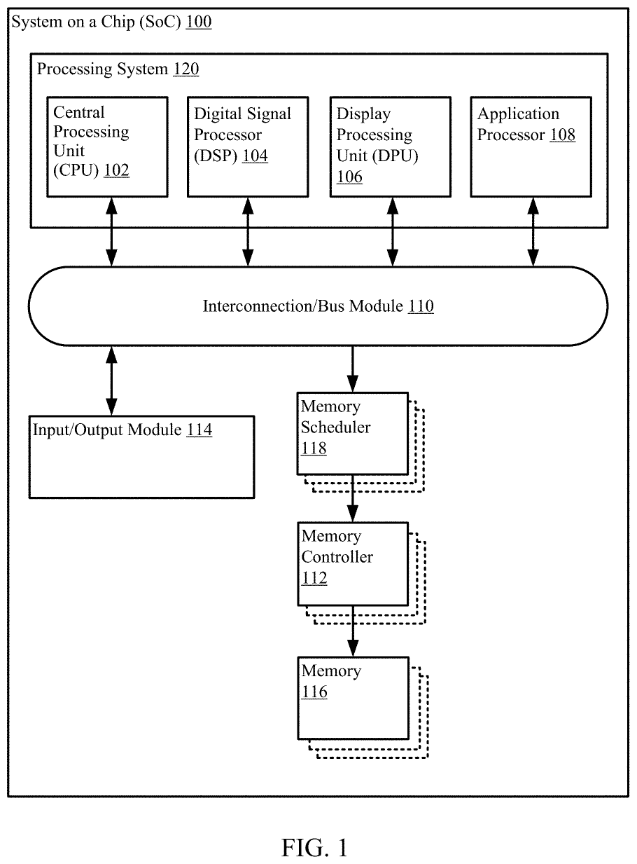

FIG. 1 is a block diagram illustrating an exemplary system-on-chip (SoC) 100 suitable for implementing various aspects of the present disclosure. The SoC 100 includes a processing system 120 that includes a plurality of heterogeneous processors such as a central processing unit (CPU) 102, a digital signal processor (DSP) 104, a display processing unit (DPU) 106, and an application processor 108. Of course, the processing system 120 may include any suitable number and type of processor; as such, the foregoing are provide by way of example. The processing system 120 may include one or more cores, and each processor/core may perform operations independent of the other processors/cores. Each of the heterogeneous processors 102, 104, 106, and 108 may be organized in close proximity to one another (e.g., on a single substrate, die, integrated chip, etc.) so that they may operate at a much higher frequency/clock-rate than would be possible if the signals were to travel off-chip. The proximity of the cores may also allow for the sharing of on-chip memory and resources (e.g., voltage rail), as well as for more coordinated cooperation between cores.

The SoC 100 may include an input/output (I/O) module 114 configured for communicating with resources external to the SoC 100. For example, the I/O module 114 includes an input/output interface (e.g., a bus architecture or interconnect) or a hardware design for performing specific functions (e.g., a memory, a wireless device, and a digital signal processor). In some examples, the I/O module includes circuitry to interface with peripheral devices, such as a memory device located off-chip.

The processing system 120 is interconnected with one or more subsystems and modules via a bus module 110 which may include an array of reconfigurable logic gates and/or implement bus architecture (e.g., CoreConnect, advanced microcontroller bus architecture (AMBA), etc.). Bus module 110 communications may be provided by advanced interconnects, such as high performance networks on chip (NoCs). The interconnection/bus module 110 may include or provide a bus mastering system configured to grant SoC components (e.g., processors, peripherals, etc.) exclusive control of the bus (e.g., to transfer data in burst mode, block transfer mode, etc.) for a set duration, number of operations, number of bytes, etc. In some cases, the bus module 110 may implement an arbitration scheme to prevent multiple master components from attempting to drive the bus simultaneously.

In certain aspects, the processing system 120 is communicatively coupled to a memory scheduler 118 via the bus module 110. The memory scheduler 118 may be configured to determine which memory transactions of a pool of memory transactions to provide to a memory controller 112. In some examples, the determination is based on one or more constraints associated with each of the memory transactions. For example, memory scheduler 118 may maintain a pool of memory transactions received from one or more masters in the processing system 120 in a buffer or cache. While the transactions may be stored in the pool such as without an order, the memory scheduler 118 may re-order or select the memory transactions for communication to the memory controller 112 based on an optimization algorithm. For example, the memory scheduler 118 may utilize the optimization algorithm to determine which transactions in the pool should be communicated during a particular window of time in order to improve bus module 110 bandwidth usage efficiency, while also respecting different levels of priority between the memory transactions.

In certain aspects, the processing system 120 is communicatively coupled to a memory controller 112 via the bus module 110 and memory scheduler 118. The memory controller 112 may be a specialized hardware module configured to receive various memory transactions from multiple masters, and address and communicate the memory transactions to the memory 116. The multiple masters may include one or more processors and/or applications operating on the processing system 120. The memory controller 112 may also manage maintenance (e.g., refresh cycles), and other suitable aspects of the memory 116. Usage of the memory 116 by, for example, processing system 120, may be subject to operational requirements, such as memory refresh handling, pre-charging, interoperable protocol compliance, etc. In some examples, such requirements are enforced by the memory controller 112 and may result in transaction pattern dependent performance. That is, memory requirements may cause the memory controller 112 to pass memory transactions to the memory 116 without ordering the transactions in any deliberate manner. Thus, as described in more detail below, the memory scheduler 118 may pass the memory transactions to the memory controller 112 in an order that improves memory access and traffic between the processing system 120 and the memory controller 112.

The memory controller 112 may comprise one or more processors configured to perform operations disclosed herein. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. As illustrated, the memory 116 and memory controller 112 are located on-chip; however, it should be noted that in some examples, one or more of the memory 116 and memory controller 112 may be located off-chip.

In certain aspects, the memory 116 is a computer-readable storage medium having an interface to the processing system 120 via the bus module 110. As discussed, the memory 116 may be implemented on or off the SoC 100. The memory 116 may provide volatile storage, such as DRAM, for the processing system 120 and/or other aspects of the SOC 100. Memory 116 may also include multiple buffer and/or cache memory aspects for storing memory transactions in pool to be executed.

The memory scheduler 118 may be configured to determine which memory transactions in the pool of memory transactions to provide to the memory controller 112, based on one or more constraints associated with each of the memory transactions. For example, memory scheduler 118 may maintain a pool of memory transactions received from one or more masters in the processing system 120 in a buffer or cache. While the transactions may be stored in the pool in without an order, the memory scheduler 118 may re-order or select the memory transactions for communication to the memory controller 112 based on an optimization algorithm. For example, the memory scheduler 118 may utilize the optimization algorithm to determine which transactions in the pool should be communicated during a particular window of time in order to improve bus module 110 bandwidth usage efficiency, while also respecting different levels of priority between the memory transactions.

Example Methods for Scheduling Memory Transactions

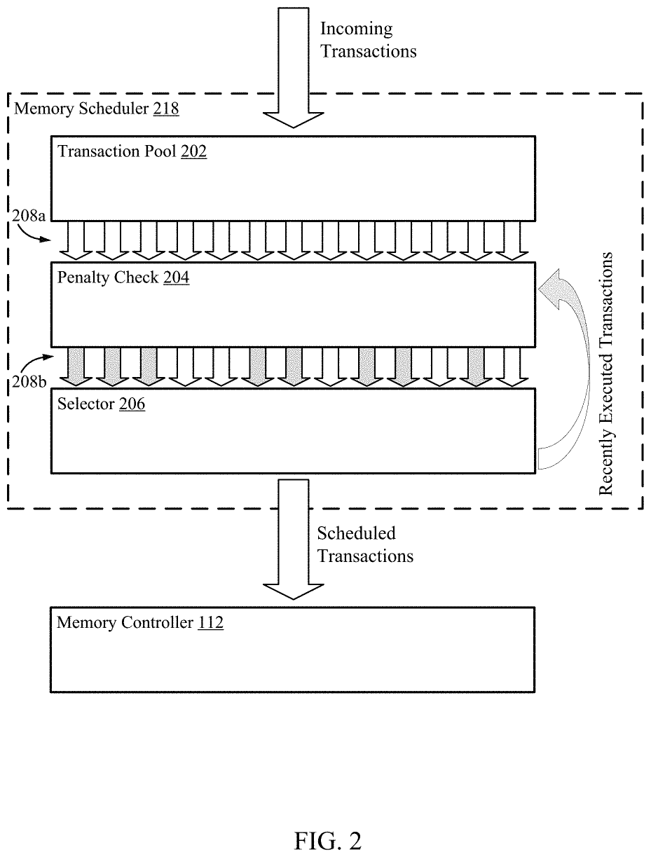

FIG. 2 is a block diagram conceptually illustrating an example embodiment of a memory scheduler 218 (e.g., memory scheduler 118 of FIG. 1) for scheduling communication of memory transactions to improve bandwidth efficiency, in accordance with certain aspects of the present disclosure. As illustrated, the memory scheduler 218 includes a transaction pool 202 configured to receive and store a plurality of memory transactions prior to their communication to the memory controller 112. The transaction pool 202 may be implemented using a buffer or cache memory (e.g., a buffer or cache separate from memory 116 of FIG. 1). Memory scheduler 218 also includes a penalty check 204 and a selector 206. The penalty check 204 and selector 206 may be comprised of hardware circuitry (e.g., ASIC, FPGA, etc.) and/or software that is executed by a processor (e.g., a processor associated with the memory scheduler 118 of FIG. 1).

Initially, the penalty check 204 may inspect the memory transactions stored in the transaction pool 202 and perform a penalty check process. In some examples, the penalty check process may determine which memory transactions in the transaction pool 202 can be performed immediately (or soonest), in view of a memory status. The memory status (shown in FIG. 2 as “Recently Executed Transactions”) may include a date and/or time of a most recent memory transaction of each bank of the memory 116. The memory status may be maintained by the selector 206 in a buffer or cache memory (e.g., a buffer or cache portion separate from memory 116 of FIG. 1), and updated by the selector 206 each time a memory transaction is passed to the memory controller 112. As illustrated, the penalty check 204 can access the memory status to determine any possible penalties associated with memory transactions.

Generally, certain memory transactions may require delays in their execution based on previously executed memory transactions. For example, if the last executed memory transaction included a “read” transaction, then in order for a “write” transaction to follow, a time delay between the two transactions may be required. This may also be true if a read transaction is to follow a write transaction. In another example, a delay may be required between two memory transactions that are addressed to the same memory bank. Other delays may be imposed depending on the type of memory and the technical standards (e.g., joint electron tube engineering council (JEDEC), etc.) associated with the memory.

Thus, in certain aspects, the penalty check 204 may determine, based on recently executed memory transactions, which of the memory transactions in the transaction pool 202 can be communicated to the memory controller 112 and executed without (or with minimal) delay. For example, if the transaction pool 202 contains a write transaction and a read transaction, and a read transaction was recently executed, then the penalty check 204 may pass the read transaction to the selector 206 and temporarily reject the write transaction. This way, any delay associated with the pending memory transactions can be pushed out to a later time so that any pending transactions without a penalty can first be executed. As illustrated, the transaction pool 202 includes thirteen memory transactions 208a which the penalty check 204 analyzes to determine which transactions do not require a delay prior to their execution. Once determined, the penalty check 204 passes one or more transactions that do not require a delay (e.g., transactions 208b) to a selector 206. As illustrated, five of the original thirteen transactions do not require a delay, and are passed to the selector. The selector 206 may then communicate any of the transactions it receives to the memory controller 112 for execution. The decision process applied by selector 206 to select a transaction among the candidates may be arbitrary, but may include any suitable decision process in other embodiments.

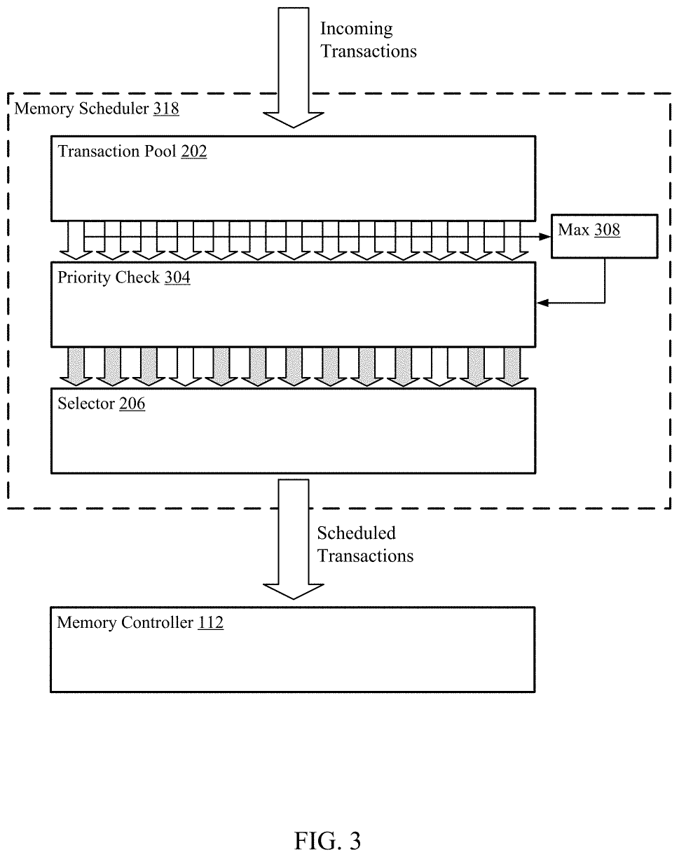

FIG. 3 is a block diagram conceptually illustrating an example embodiment of a memory scheduler 318 (e.g., memory scheduler 118 of FIG. 1) for scheduling communication of memory transactions according to priority, in accordance with certain aspects of the present disclosure. As illustrated, the memory scheduler 318 includes a transaction pool 202 configured to receive and store a plurality of memory transactions prior to their communication to the memory controller 112. The transaction pool 202 may be implemented using a buffer or cache memory (e.g., a buffer or cache separate from memory 116 of FIG. 1). Memory scheduler 318 also includes a priority check 304 and a selector 206. The priority check 304 and selector 206 may be comprised of hardware circuitry (e.g., ASIC, FPGA, etc.) and/or software that is executed by a processor (e.g., a processor associated with the memory scheduler 118 of FIG. 1).

Initially, the priority check 304 inspects the memory transactions stored in the transaction pool 202 and performs a process configured to determine a maximum priority of the memory transactions. For example, the priority check 304 may include priority hardware circuitry and/or software 308 configured to determine a highest priority occurring among the memory transactions. In some examples, one or more transactions may include an indication of its level of priority. In some examples, this priority level may be dynamically updated, while the transaction is waiting. In some examples, the priority level may represent the importance to for the system to obtain a response to the transaction. In some examples, the priority may represent the importance for the system to release resources used by the transaction, for instance in pool 202. Once the highest level of priority among the memory transactions is determined, the priority check 304 may pass only the memory transactions having that level of priority to the selector 206. In the example illustrated, only two of the 13 transactions (shown as two white arrows among eleven grey arrows) are allowed to pass to the selector 206. That is, only two of the 13 transactions have the highest occurring level of priority among all the transactions. The selector 206 may then pass those two transactions to the memory controller 112 for execution. The decision process applied by selector 206 to select a transaction among the candidates may be arbitrary, but may include any suitable decision process in other embodiments.

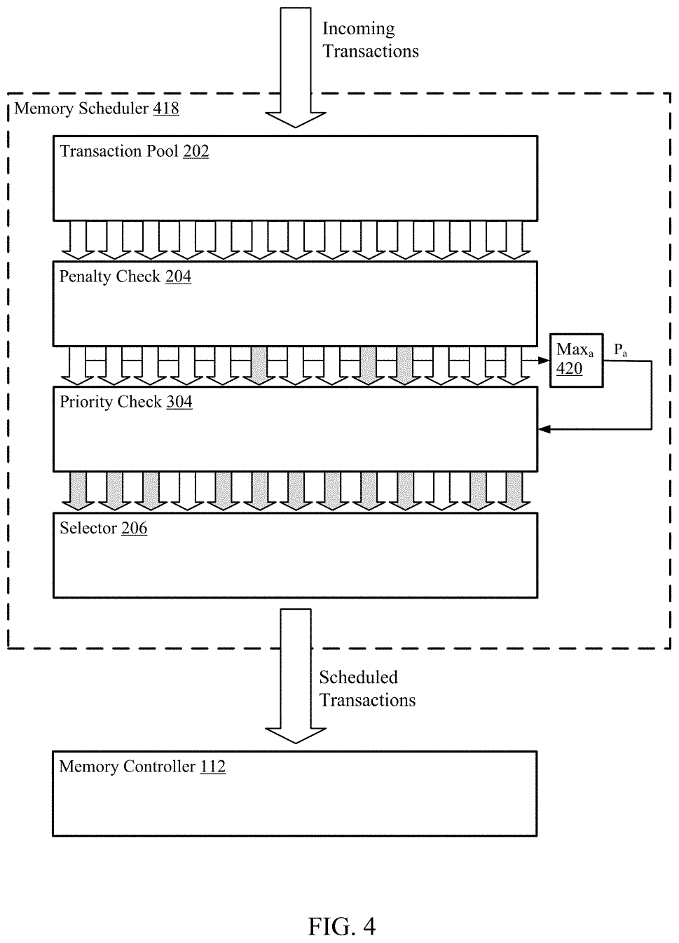

FIG. 4 is a block diagram conceptually illustrating an example embodiment of a memory scheduler 418 (e.g., memory scheduler 118 of FIG. 1) for scheduling communication of memory transactions according to bandwidth efficiency and priority, in accordance with certain aspects of the present disclosure. As illustrated, the memory scheduler 418 includes a transaction pool 202 configured to receive and store a plurality of memory transactions prior to their communication to the memory controller 112. Memory scheduler 418 also includes a penalty check 204 (e.g., penalty check 204 of FIG. 2), a priority check 304 (e.g., priority check 304 of FIG. 3), and a selector 206 (e.g., selector 206 of FIG. 2).

Initially, the penalty check 204 inspects the memory transactions stored in the transaction pool 202 and performs a process configured to determine, based on recently executed memory transactions, which of the memory transactions in the transaction pool 202 can be communicated to the memory controller 112 and executed without (or with minimal) delay. One or more memory transactions may qualify to be passed on to the priority check 304. As discussed, the priority check 304 may include priority hardware circuitry and/or software 308 configured to determine a highest priority occurring among the memory transactions that are passed to it. Once the highest level of priority among the memory transactions is determined, the priority check 304 may pass only the memory transactions having that level of priority to the selector 206. The selector 206 may then send one or more of those transactions to the memory controller 112 for execution.

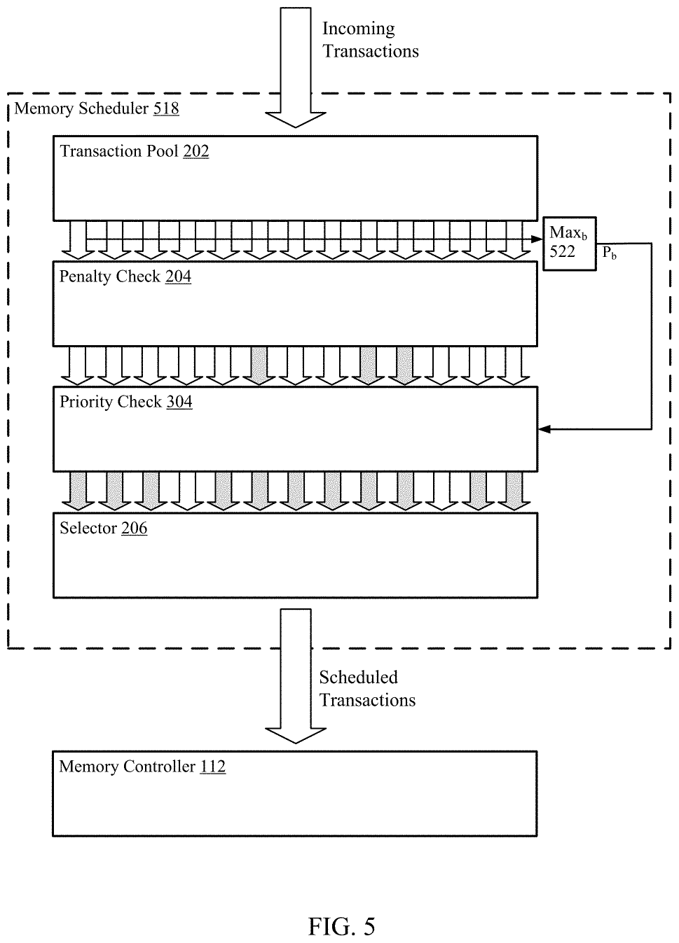

FIG. 5 is a block diagram conceptually illustrating an example embodiment of a memory scheduler 518 (e.g., memory scheduler 118 of FIG. 1) for scheduling communication of memory transactions according to bandwidth efficiency and priority, in accordance with certain aspects of the present disclosure. As illustrated, the memory scheduler 518 includes a transaction pool 202 configured to receive and store a plurality of memory transactions prior to their communication to the memory controller 112. Memory scheduler 518 also includes a penalty check 204 (e.g., penalty check 204 of FIG. 2), a priority check 304 (e.g., priority check 304 of FIG. 3), and a selector 206 (e.g., selector 206 of FIG. 2).

Initially, a priority module 522 may be configured to determine a first maximum priority level (P_{b}) of memory transactions in the transaction pool 202. For example, the priority module 522 may evaluate the memory transactions in the transaction pool 202 to determine the first maximum priority level occurring among those transactions. In this example, the priority module 522 outputs P_{b} to the priority check 304, and the priority check 304 will only pass memory transactions that have a higher or equal priority to P_{b}.

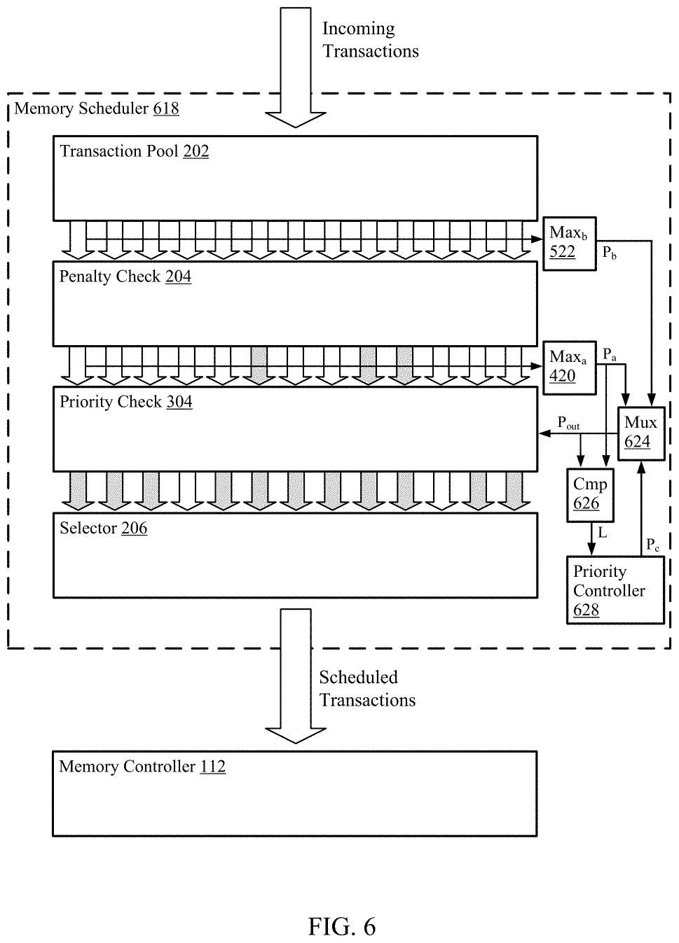

FIG. 6 is a block diagram conceptually illustrating an example embodiment of a memory scheduler 618 (e.g., memory scheduler 118 of FIG. 1) for scheduling communication of memory transactions to improve bandwidth efficiency while also scheduling according to priority, in accordance with certain aspects of the present disclosure. As illustrated, the memory scheduler 618 includes a transaction pool 202 configured to receive and store a plurality of memory transactions prior to their communication to the memory controller 112. The transaction pool 202 may be implemented using a buffer or cache memory (e.g., a buffer or cache separate from memory 116 of FIG. 1). Memory scheduler 618 also includes a penalty check 204, a priority check 304, and a selector 206. The penalty check 204, the priority check 304, and the selector 206 may be comprised of hardware circuitry (e.g., ASIC, FPGA, etc.) and/or software that is executed by a processor (e.g., a processor of the processing system 120 and/or associated with the memory scheduler 118 of FIG. 1).

In the example of FIG. 6, the memory scheduler 618 may also include penalty module 420 configured to determine a second maximum priority level (Pₐ) among all the transactions in the transaction pool 202, priority module 522 configured to determine a first maximum priority level (P_{b}), a multiplexer 624 for outputting an indication of a threshold priority level (Pₒᵤₜ) based on a comparator 626 output and a priority controller 628 output. In some examples, penalty module 420, priority module 522, multiplexer 624, comparator 626, and priority controller 628 may include hardware circuitry (e.g., ASIC, FPGA, etc.) and/or software aspects (e.g., memory scheduler 118 of FIG. 1).

In certain aspects, similar to the penalty check 204 of FIG. 2, the penalty check 204 may determine, based on previously executed memory transactions, which of the memory transactions in the transaction pool 202 can be communicated to the memory controller 112 and executed without (or with minimal) delay or penalty. As discussed, the penalty module 420 is configured to determine the second maximum priority level (Pₐ) among all the transactions in the transaction pool 202. The penalty module 420 may output an indication (e.g., Pₐ) of the second maximum priority level to a multiplexer 624.

In certain aspects, the priority module 522 is configured to determine a first maximum priority level (P_{b}). For example, the priority module 522 may evaluate the transactions that pass the penalty check 204 to determine the first maximum priority level occurring among those transactions. As such, P_{b}<Pₐ. In this example, the priority module 522 outputs P_{b} to the multiplexer 624 and a comparator 626.

The multiplexer 624 also receives a configurable control priority level (P_{c}) indicating a particular priority level that the multiplexer 624 uses to select Pₒᵤₜ. In certain aspects, being a selecting signal of the multiplexer, P_{c} can be utilized to set a floor priority value to prevent memory transactions of lesser priority from being passed to the selector 206. In one example, the threshold priority level (Pₒᵤₜ) output by multiplexer 624 is determined based on whether Pₐ>P_{c}. In such an example, if Pₐ>P_{c}, then Pₒᵤₜ=Pₐ; otherwise, Pₒᵤₜ=P_{b}. That is, if the highest transaction priority level that occurs in the transaction pool is greater than the control priority level, then the priority check 304 will only send transactions having at least the Pₐ priority to the selector 206. This is because the priority check 304 will use the threshold priority level (Pₒᵤₜ) to prevent passage of any transactions that do not have at least the same priority as Pₒᵤₜ.

For example, if there are seven priority levels (e.g., where a “0” represents a maximum priority, and a “6” represents a minimum priority), then a P_{c}=0 would result in a scheduler that operates by only allowing the highest priority transactions to be communicated to the selector 206 and memory controller 112. That is, a transaction with a priority of “1” would only be communicated to the memory controller after all transactions with a priority of “0” have been communicated. As such, a transaction with a priority of “2” would only be communicated to the memory controller after all transactions with a priority of “1” have been communicated, and so on. In another example, P_{c}=6 would result in a scheduler that operates by determining which transactions can be executed without a time delay or penalty, then of those transactions, the highest priority transactions would be the first to be communicated to the selector 206 and the memory controller 112.

The comparator 626 may be configured to measure bandwidth loss. In some examples, the comparator 626 receives Pₒᵤₜ and P_{b}, and asserts a loss signal (L) when the comparator determines that P_{b}<Pₒᵤₜ. That is, the loss is asserted when at least one transaction is qualified by the penalty check 204, but will be prevented from being passed to the selector 206 by the priority check 304 because the priority of the transaction is not greater than or equal to Pₒᵤₜ. In such a case, the comparator 626 communicates the loss signal to the priority controller 628, which may adjust the control priority level (P_{c}) in order to allow transactions having a broader range of priorities through to the selector 206 and memory controller 112.

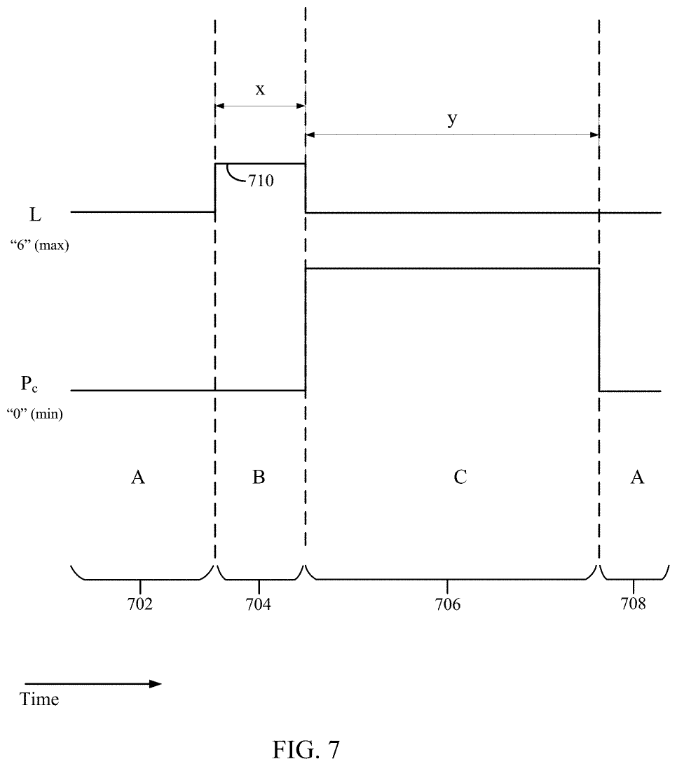

As discussed, the priority controller 628 is configured to receive the loss signal from the comparator 626 and adjust the control priority level (P_{c}) to allow more transactions to be communicated to the selector and prevent similar losses from occurring. Referring now to FIG. 7, the priority controller 628 may refrain from changing the control priority level until a loss signal has been received for a configurable number of contiguous clock cycles (x). The number of clock cycles can be any suitable number of cycles, for example, 1 clock cycle, 50 clock cycles, or 1000 clock cycles.

FIG. 7 is a clock signal timing diagram illustrating an example scenario for reducing bandwidth loss in memory transaction scheduling, in accordance with certain aspects of the present disclosure. During a first duration of time 702, the loss signal (L) is not asserted by the comparator 626. As such, the initial state of the control priority level (P_{c}) is not changed. In this example, the control priority level is such that memory transactions are passed based on priority-oriented decision making. That is, the threshold priority level (Pₒᵤₜ) may be a relatively high priority, preventing lower priority transactions from being passed to the selector 206. However, during a second duration of time 704, a loss signal 710 is received by the priority controller 628 for the “x” number of clock cycles. Here, the priority controller 628 may change the control priority level to the multiplexer 624 to allow passage of transactions having a broader range of priority levels to be passed to the selector 206. For example, the priority controller 628 may change the control priority level so that the threshold transaction priority is lowered, thereby allowing more transactions to be passed to the selector 206 and eliminating the loss signal 710.

In some examples, the third duration of time 706 may be based on one of the second duration of time 704, or the number of clock cycles during which the loss signal was received by the priority controller 628. In one example, the duration (y) of the third duration of time 706 may be determined by multiplying the x number of clock cycles by a configurable multiplier (K). For example, y=K*x.

Although FIG. 7 illustrates a binary, two-state representation of the control priority level (P_{c}), other embodiments may be directed to multiple levels of the control priority level. For instance, using the example above, where there are seven priority levels (e.g., where a “0” represents a maximum priority, and a “6” represents a minimum priority), the priority controller 628 may change the control priority level by gradually stepping through the different levels. In one example, if P_{c}=0 during the first time duration 702 and the second time duration 704, then the priority controller 628 may incrementally change the control priority level over the course of the third duration of time 706 such that the control priority level corresponds to one or more priority levels. In one example, at the beginning of the third duration of time 706, the control priority level may be changed from P_{c}=0 to P_{c}=1. Additional changes to the priority level can be made during the course of the third duration of time.

Moreover, in some embodiments, the priority controller 628 may make larger incremental changes to the control priority level. For example, instead of a change from P_{c}=0 to P_{c}=1, the change may instead be from P_{c}=0 to P_{c}=2. Greater incremental changes are also contemplated.

Once the third duration of time has elapsed, the priority controller 628 may return the control priority level to its previous state during a fourth duration of time 708.

Referring now back to FIG. 6, once the memory transactions are passed to the selector 206, the selector 206 may pass the memory transactions to the memory controller 112 for execution. The selector 206 may pass the memory transactions to the memory controller 112 in any suitable order, including first-in first-out (FIFO) or by arbitrary selection. The memory controller 112 may then execute the memory transactions (e.g., read, write, etc.) on memory 116.

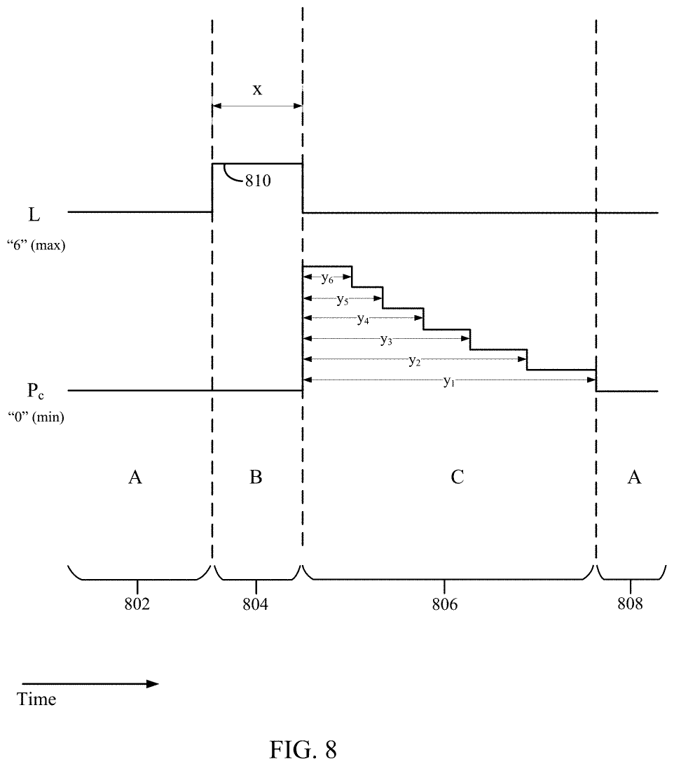

FIG. 8 is a clock signal timing diagram illustrating an example scenario for reducing bandwidth loss in memory transaction scheduling, in accordance with certain aspects of the present disclosure. During a first duration of time 802, the loss signal (L) is not asserted by the comparator 626. As such, the initial state of the control priority level (P_{c}) is not changed. During a second duration of time 804, a loss signal 810 is received by the priority controller 628 for the “x” number of clock cycles. Similar to FIG. 7, the priority controller 628 may change the control priority level to the multiplexer 624 to allow passage of transactions having a broader range of priority levels to be passed to the selector 206. However, in this example, the priority controller 628 may gradually reduce the range of priority levels to be passed to the selector 206 during a third duration of time 806. By a fourth duration of time 808, the control priority level is returned to its original state.

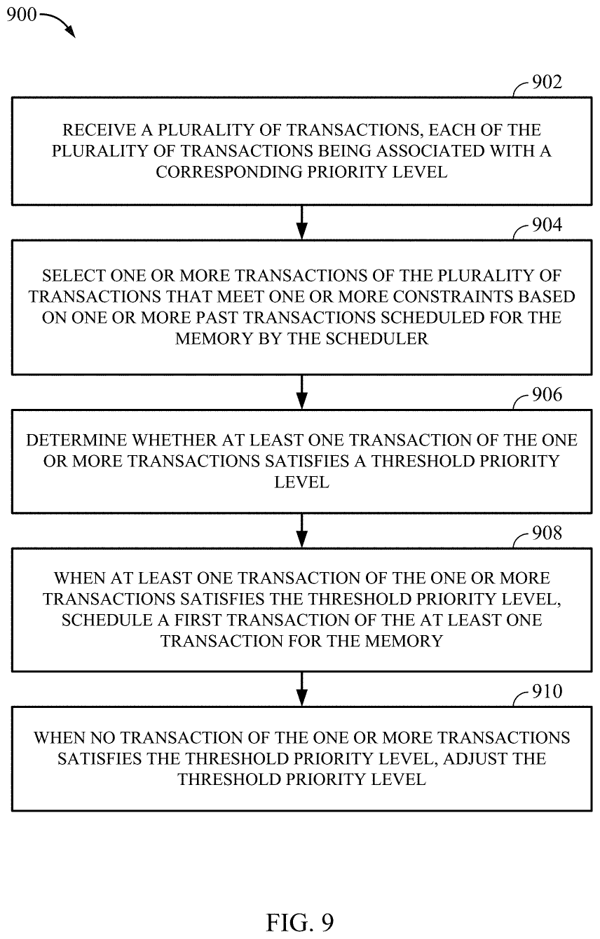

FIG. 9 is a flow diagram illustrating example operations 900 for scheduling transactions for a memory by a scheduler. The operations 900 may be performed, for example, by a memory scheduler (e.g., such as one of the memory schedulers of FIGS. 1-6). Operations 900 may be implemented as software components that are executed and run on one or more processors (e.g., processing system 120 of FIG. 1). In certain aspects, the transmission and/or reception of data by various hardware components may be implemented via a bus interface (e.g., bus module 110 of FIG. 1).

The operations 900 may begin, at block 902, by receiving a plurality of transactions, each of the plurality of transactions being associated with a corresponding priority level. Referring to FIG. 6 for purposes of providing an example, the plurality of transactions may be received by the memory scheduler 618 and stored in a transaction pool 202.

The operations 900 may proceed to block 904 by selecting one or more transactions of the plurality of transactions that meet one or more constraints based on one or more past transactions scheduled for the memory by the scheduler. For example, the penalty check 204 may determine which transactions of the plurality of transactions will not be subject to a delay or penalty prior to their execution. As discussed, the constraints may include, for example, a read/write transaction following a write/read transaction which may require a processing delay for a duration of time. In another example, a processing delay may be required between two memory transactions that are addressed to the same memory bank.

The operations 900 proceed to block 906 by determining whether at least one transaction of the one or more transactions satisfies a threshold priority level. For example, the priority check 304 may receive one or more transactions of the plurality of transactions that will not be subject to a delay, then determine which of the one or more transactions have a priority greater than or equal to the indication of a threshold priority level (Pₒᵤₜ) output by the multiplexer 624.

When at least one transaction of the one or more transactions satisfies the threshold priority level, the operations 900 proceed to block 908 by scheduling a first transaction of the at least one transaction for the memory. That is, when the priority check 304 determines that one or more of the plurality of transactions have a priority greater than or equal to the indication of a threshold priority level (Pₒᵤₜ) output by the multiplexer 624, the priority check 304 may output the one or more transactions to the selector 206 for execution by the memory.

When no transaction of the one or more transactions satisfies the threshold priority level, the operations 900 proceed to block 910 by adjusting the threshold priority level. That is, when the priority check 304 determines that one or more of the plurality of transactions do not have a priority greater than or equal to the indication of the threshold priority level (Pₒᵤₜ) output by the multiplexer 624, the comparator 626 may signal in indication of a loss to the priority controller 628. In response, the priority controller 628 may adjust the control priority level (P_{c}) in order to allow transactions having a broader range of priorities through to the selector 206 and memory controller 112.

In certain aspects, the operations 900 further include determining a first maximum priority level corresponding to a maximum priority level among the corresponding priority levels of the one or more transactions, wherein determining whether at least one transaction of the one or more transactions satisfies the threshold priority level comprises determining whether the first maximum priority level is less than the threshold priority level.

In certain aspects, the operations 900 further include determining a first maximum priority level corresponding to a maximum priority level among the corresponding priority levels of the one or more transactions; and determining a second maximum priority level corresponding to a maximum priority level among the corresponding priority levels of the plurality of transactions, wherein the threshold priority level is based on the first maximum priority level, the second maximum priority level, and a control priority level.

In certain aspects, the threshold priority level is equal to the second maximum priority level when the second maximum priority level is greater than the control priority level, and wherein the threshold priority level is equal to the first maximum priority level when the second maximum priority level is less than or equal to the control priority level.

In certain aspects, adjusting the threshold priority level comprises adjusting the control priority level.

In certain aspects, adjusting the control priority level comprises changing a value of the control priority level from a first value to one or more other values for one or more corresponding periods of time and returning the control priority level to the first value after the one or more corresponding periods of time.

In certain aspects, the first value corresponds to a lowest priority level, and the one or more other values correspond to one or more priority levels higher than the lowest priority level.

In certain aspects, the one or more constraints comprise one or more of: any transaction of a first type is scheduled at least a threshold time after any transaction of a second type is scheduled; and any transaction to a given bank of memory is scheduled at least a threshold time after any other transaction to the given bank is schedule.

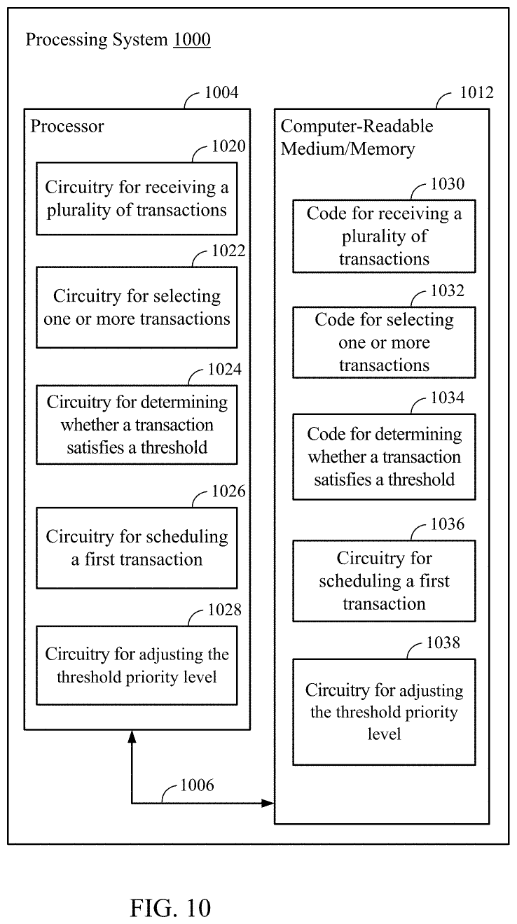

FIG. 10 illustrates a processing system 1000 that may include various components (e.g., corresponding to means-plus-function components) configured to perform operations for the techniques disclosed herein, such as the operations illustrated in FIG. 9. The processing system 1000 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 9, or other operations for performing the various techniques discussed herein for memory arbitration.

In certain aspects, computer-readable medium/memory 1012 stores code 1030 for receiving a plurality of transactions, each of the plurality of transactions being associated with a corresponding priority level; code 1032 for selecting one or more transactions of the plurality of transactions that meet one or more constraints based on one or more past transactions scheduled for the memory by the scheduler; code 1034 for determining whether at least one transaction of the one or more transactions satisfies a threshold priority level; code 1036 for, when at least one transaction of the one or more transactions satisfies the threshold priority level, scheduling a first transaction of the at least one transaction for the memory; and code 1038 for, when no transaction of the one or more transactions satisfies the threshold priority level, adjusting the threshold priority level.

In certain aspects, the processor 1004 has circuitry configured to implement the code stored in the computer-readable medium/memory 1012. The processor 1004 includes circuitry 1020 for receiving a plurality of transactions, each of the plurality of transactions being associated with a corresponding priority level; circuitry 1022 for selecting one or more transactions of the plurality of transactions that meet one or more constraints based on one or more past transactions scheduled for the memory by the scheduler; circuitry 1024 for determining whether at least one transaction of the one or more transactions satisfies a threshold priority level; circuitry 1026 for, when at least one transaction of the one or more transactions satisfies the threshold priority level, scheduling a first transaction of the at least one transaction for the memory; and circuitry 1028 for, when no transaction of the one or more transactions satisfies the threshold priority level, adjusting the threshold priority level.

Additional Considerations

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for” or simply as a “block” illustrated in a figure.

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise. The software may be stored on non-transitory computer-readable medium included in the processing system.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A method for scheduling transactions for a memory by a scheduler, the method comprising:
receiving a plurality of transactions, each of the plurality of transactions being associated with a corresponding priority level;
selecting one or more transactions of the plurality of transactions that meet one or more constraints based on one or more past transactions scheduled for the memory by the scheduler;
determining whether at least one transaction of the one or more transactions satisfies a threshold priority level;
when at least one transaction of the one or more transactions satisfies the threshold priority level, scheduling a first transaction of the at least one transaction for the memory; and
adjusting the threshold priority level.

2. The method of claim 1, further comprising:
determining a first maximum priority level corresponding to a maximum priority level among the corresponding priority levels of the one or more transactions, wherein determining whether at least one transaction of the one or more transactions satisfies the threshold priority level comprises determining whether the first maximum priority level is less than the threshold priority level; and
wherein adjusting the threshold priority level comprises adjusting the threshold priority level when no transaction of the one more transactions satisfy the threshold priority level.

3. The method of claim 1, further comprising:
determining a first maximum priority level corresponding to a maximum priority level among the corresponding priority levels of the one or more transactions; and
determining a second maximum priority level corresponding to a maximum priority level among the corresponding priority levels of the plurality of transactions, wherein the threshold priority level is based on the first maximum priority level, the second maximum priority level, and a control priority level.

4. The method of claim 3, wherein the threshold priority level is equal to the second maximum priority level when the second maximum priority level is greater than the control priority level, and wherein the threshold priority level is equal to the first maximum priority level when the second maximum priority level is less than or equal to the control priority level.

5. The method of claim 3, wherein adjusting the threshold priority level comprises adjusting the control priority level.

6. The method of claim 5, wherein adjusting the control priority level comprises changing a value of the control priority level from a first value to one or more other values for one or more corresponding periods of time and returning the control priority level to the first value after the one or more corresponding periods of time.

7. The method of claim 6, wherein the first value corresponds to a lowest priority level, and the one or more other values correspond to one or more priority levels higher than the lowest priority level.

8. The method of claim 1, wherein the one or more constraints comprise one or more of:
any transaction of a first type is scheduled at least a threshold time after any transaction of a second type is scheduled; and
any transaction to a given bank of memory is scheduled at least a threshold time after any other transaction to the given bank is schedule.

9. A scheduler configured to schedule transactions for a memory, the scheduler comprising:
a memory; and
a processor coupled to the memory, the processor and the memory configured to:
receive a plurality of transactions, each of the plurality of transactions being associated with a corresponding priority level;
select one or more transactions of the plurality of transactions that meet one or more constraints based on one or more past transactions scheduled for the memory by the scheduler;
determine whether at least one transaction of the one or more transactions satisfies a threshold priority level; and
when at least one transaction of the one or more transactions satisfies the threshold priority level, schedule a first transaction of the at least one transaction for the memory; and
adjust the threshold priority level.

10. The scheduler of claim 9, wherein the processor and the memory are further configured to determine a first maximum priority level corresponding to a maximum priority level among the corresponding priority levels of the one or more transactions,
wherein the processor and memory, being configured to determine whether at least one transaction of the one or more transactions satisfies the threshold priority level, are further configured to determine whether the first maximum priority level is less than the threshold priority level.

11. The scheduler of claim 9, wherein the processor and the memory are further configured to:
determine a first maximum priority level corresponding to a maximum priority level among the corresponding priority levels of the one or more transactions; and
determine a second maximum priority level corresponding to a maximum priority level among the corresponding priority levels of the plurality of transactions, wherein the threshold priority level is based on the first maximum priority level, the second maximum priority level, and a control priority level.

12. The scheduler of claim 11, wherein the threshold priority level is equal to the second maximum priority level when the second maximum priority level is greater than the control priority level, and wherein the threshold priority level is equal to the first maximum priority level when the second maximum priority level is less than or equal to the control priority level.

13. The scheduler of claim 11, wherein adjusting the threshold priority level comprises adjusting the control priority level.

14. The scheduler of claim 13, wherein the processor and memory, being configured to adjust the control priority level, are further configured to change a value of the control priority level from a first value to one or more other values for one or more corresponding periods of time and returning the control priority level to the first value after the one or more corresponding periods of time.

15. The scheduler of claim 14, wherein the first value corresponds to a lowest priority level, and the one or more other values correspond to one or more priority levels higher than the lowest priority level.

16. The scheduler of claim 9, wherein the one or more constraints comprise one or more of:
any transaction of a first type is scheduled at least a threshold time after any transaction of a second type is scheduled; and
any transaction to a given bank of memory is scheduled at least a threshold time after any other transaction to the given bank is schedule.

17. An apparatus configured to schedule transactions for a memory, the apparatus comprising:
means for receiving a plurality of transactions, each of the plurality of transactions being associated with a corresponding priority level;
means for selecting one or more transactions of the plurality of transactions that meet one or more constraints based on one or more past transactions scheduled for the memory by the scheduler;
means for determining whether at least one transaction of the one or more transactions satisfies a threshold priority level;
when at least one transaction of the one or more transactions satisfies the threshold priority level, means for scheduling a first transaction of the at least one transaction for the memory; and
means for adjusting the threshold priority level.

18. The apparatus of claim 17, further comprising:
means for determining a first maximum priority level corresponding to a maximum priority level among the corresponding priority levels of the one or more transactions, wherein means for determining whether at least one transaction of the one or more transactions satisfies the threshold priority level comprises means for determining whether the first maximum priority level is less than the threshold priority level.

19. The apparatus of claim 17, further comprising:
means for determining a first maximum priority level corresponding to a maximum priority level among the corresponding priority levels of the one or more transactions; and
means for determining a second maximum priority level corresponding to a maximum priority level among the corresponding priority levels of the plurality of transactions, wherein the threshold priority level is based on the first maximum priority level, the second maximum priority level, and a control priority level.

20. The apparatus of claim 19, wherein the threshold priority level is equal to the second maximum priority level when the second maximum priority level is greater than the control priority level, and wherein the threshold priority level is equal to the first maximum priority level when the second maximum priority level is less than or equal to the control priority level.
